(19) United States
(12) Patent Application Publication
(10) Pub. No.: US 2026/0127011 A1
(43) Pub. Date: May 7, 2026

(54) METHOD, APPARATUS, DEVICE AND STORAGE MEDIUM FOR CONFIGURING A PLUG-IN

(71) Applicant: DOUYIN VISION CO., LTD., Beijing (CN)

(72) Inventors: Yong Liu, Beijing (CN); Pengfei Duan, Beijing (CN)

(21) Appl. No.: 19/114,426

(22) PCT Filed: Mar. 21, 2024
(86) PCT No.: PCT/CN2024/083066

§ 371 Date: Mar. 21, 2025

(51) Int. Cl. G06F 9/445

(52) U.S. Cl. CPC G06F 9/44526

(57) ABSTRACT

A method, an apparatus, a device and a computer readable storage medium for configuring a plug-in. The method comprises: presenting a management panel in a development interface of a plug-in, the management panel being configured to display or edit metadata of at least one function associated with the plug-in (210); in response to a request for deploying the plug-in, generating description information corresponding to a target application platform based on the metadata (220); and providing description information to the target application platform to set at least one configuration parameter of the plug-in in the target application platform (230). Thereby, the efficiency of configuring a plug-in can be improved.

### FIELD

Example embodiments of the present disclosure generally relate to the field of computer, and in particular, to a method, an apparatus, a device and a computer readable storage medium for configuring a plug-in.

### BACKGROUND

With the development of computer technology, people may develop various machine learning model based applications, for example, Bot or agent. Plug-in is an important capability for applications. Some plug-in developers may develop and publish corresponding plug-in(s) for users to build applications using the plug-in(s).

### SUMMARY

In a first aspect of the present disclosure, a method for configuring a plug-in is provided. The method comprises: presenting a management panel in a development interface of a plug-in, wherein the management panel is configured to display or edit metadata of at least one function associated with the plug-in; in response to the request for deploying the plug-in, generating description information corresponding to the target application platform based on the metadata; and providing description information to the target application platform to set at least one configuration parameter of the plug-in in the target application platform.

In a second aspect of the present disclosure, an apparatus for configuring a plug-in is provided. The apparatus includes: a presentation module configured to present a management panel in a development interface of a plug-in, the management panel being configured to display or edit metadata of at least one function associated with the plug-in; a generation module configured to, in response to a request for deploying the plug-in, generate description information corresponding to a target application platform based on the metadata; and a provision module configured to provide description information to the target application platform to set at least one configuration parameter of the plug-in in the target application platform.

In a third aspect of the present disclosure, an electronic device is provided. The device includes at least one processing unit; and at least one memory coupled to the at least one processing unit and storing instructions for execution by the at least one processing unit. The instructions, when executed by the at least one processing unit, cause the device to perform the method of the first aspect.

In a fourth aspect of the present disclosure, a computer-readable storage medium is provided. The computer-readable storage medium has a computer program stored thereon, and the computer program is executable by the processor to implement the method of the first aspect.

It should be understood that the content described in this Summary section is not intended to limit the key features or important features of the embodiments of the present disclosure, nor is it intended to limit the scope of the present disclosure. Other features of the present disclosure will become readily comprehensible from the following description.

### BRIEF DESCRIPTION OF DRAWINGS

The above and other features, advantages, and aspects of various embodiments of the present disclosure will become more apparent with reference to the following detailed description in conjunction with accompanying drawings. In the drawings, the same or similar reference numbers denote the same or similar elements, wherein:

FIG. 1 illustrates a schematic diagram of an example environment in which some embodiments of the present disclosure can be implemented;

FIG. 2 shows a flowchart of a process for configuring a plug-in according to some embodiments of the present disclosure;

FIGS. 3A and 3B illustrate example development interfaces according to some embodiments of the present disclosure;

FIG. 4 illustrates a schematic diagram for plug-in development according to some embodiments of the present disclosure;

FIG. 5 illustrates a schematic structural block diagram of an example apparatus for configuring a plug-in according to some embodiments of the present disclosure; and

FIG. 6 illustrates a block diagram of an electronic device capable of implementing a plurality of embodiments of the present disclosure.

### DETAILED DESCRIPTION

Embodiments of the present disclosure will be described in more detail below with reference to the accompanying drawings. While certain embodiments of the present disclosure are shown in the accompanying drawings, it should be understood that the present disclosure may be implemented in various forms, and should not be construed as limited to the embodiments set forth herein, on the contrary, these embodiments are provided for a more thorough and complete understanding of the present disclosure. It should be understood that the drawings and embodiments of the present disclosure are for example purpose only and are not intended to limit the scope of the present disclosure.

It should be noted that the title of any section/subsection provided herein is not limiting. Various embodiments are described throughout the present document and any type of embodiments may be included in any section/subsection. Furthermore, embodiment(s) described in any section/subsection may be combined with any other embodiment(s) described in the same sections/subsection and/or different section/subsections in any manner.

In the description of embodiments of the present disclosure, terms “include” and the like should be interpreted as an open-ended include, i.e., “including but not limited to”. Term “based on” should be interpreted as “based at least in part on”. Term “one embodiment” or “the embodiment” should be interpreted as “at least one embodiment”. Term “some embodiments” should be interpreted as “at least some embodiments”. Other explicit and implicit definitions may also be included below. Term “first”, “second” and the like may refer to different or identical objects. Other explicit and implicit definitions may also be included below.

Embodiments of the present disclosure may involve data of a user, acquisition and/or use of data, and the like. All of these aspects should follow corresponding laws and regulations and related stipulations. In the embodiments of the present disclosure, all of collecting, acquiring, handling, processing, forwarding, using, etc. of data are all performed on the premise that the user knows and confirms them. Accordingly, when implementing respective embodiments of the present disclosure, types, usage scope, usage scenario, and the like of the data or information that may be involved should be notified to the user and authorization of the user should be acquired in an appropriate manner according to relevant laws and regulations. The specific manner for notification and/or authorization may vary according to actual situations and application scenarios, and the scope of the present disclosure is not limited in this respect.

If processing of personal information is involved in solutions in the present specification and embodiments, the processing will be performed on the premise of having a legal basis (for example, acquiring consent of the subject of the personal information, or necessary for fulfillment of contract, etc.), and the personal information will only be processed within a specified or agreed range. The user's rejection of processing of personal information other than necessary information required by basic function will not affect the use of the basic function by the user.

As briefly mentioned above, for applications, a plug-in is an important capability. Some plug-in developers may develop and publish corresponding plug-ins for users to build applications using plug-ins. Conventionally, when a developer desires to publish a plug-in in an application platform, the developer needs to manually configure relevant information of function(s) in the plug-in, which greatly reduces the efficiency of plug-in development.

Embodiments of the present disclosure provide a solution for configuring a plug-in. According to this solution, a management panel may be presented in a development interface of a plug-in, the management panel configured to display or edit metadata of at least one function associated with the plug-in. Further, in response to a request for deploying the plug-in, description information corresponding to the target application platform may be generated based on the metadata. Additionally, description information may be provided to the target application platform to set at least one configuration parameter of the plug-in in the target application platform.

Thereby, embodiments of the present disclosure can couple the plug-in's development environment with the application platform, so that the metadata can be synchronized to the application platform to complete automatic configuration and release of the plug-in, thereby improving the efficiency of plug-in development and configuration.

Various example implementations of this solution are further described in detail below in conjunction with the accompanying drawings.

### Example Environment

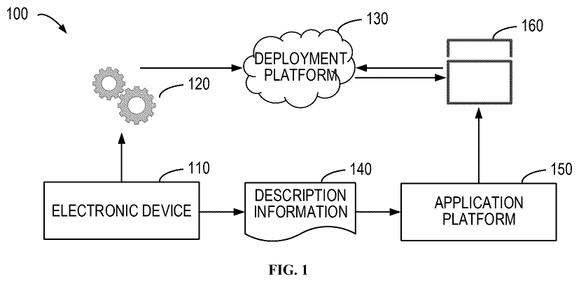

FIG. 1 illustrates a schematic diagram of an example environment 100 in which embodiments of the present disclosure can be implemented. As shown in FIG. 1, the example environment 100 may include an electronic device 110.

In some embodiments, the electronic device 110 may, for example, be deployed with an integrated development environment (IDE), or support a user's access to an online development environment through a browser. Accordingly, the user may, for example, utilize the electronic device 110 to complete code development of the plug-in 120 and may deploy the plug-in 120 to a deployment platform 130 (e.g., a cloud platform).

Further, as will be described in detail below, the electronic device 110 may, for example, also automatically generate description information 140 during deployment of the plug-in 120, such description information 140 may indicate metadata of one or more function in the plug-in 120.

Such description information 140 may be provided to an application platform 150 for setting configuration parameter(s) of the plug-in 120 in the application platform 150 and publishing the plug-in 120 as a plug-in type or an action type. Further, the application 160 created via the application platform 150 may be configured to have an ability to invoke the plug-in 120 and may invoke the plug-in 120 by accessing the deployment platform 130 to perform a corresponding processing procedure.

In some embodiments, the application platform 150 may include, for example, a platform for developing agent(s). Accordingly, the application 160 may include, for example, an agent or Bot developed based on the application platform 150.

In some examples, the electronic device 110 may be any type of mobile terminal, fixed terminal, or portable terminal, including a mobile phone, a desktop computer, a laptop computer, a notebook computer, a netbook computer, a tablet computer, a media computer, a multimedia tablet, a palmtop computer, a portable game terminal, a VR/AR device, a personal communication system (PCS) device, a personal navigation device, a personal digital assistant (PDA), an audio/video player, a digital camera/camcorder, a positioning device, a television receiver, a radio broadcast receiver, an electronic book device, a gaming device, or any combination of the foregoing, including accessories and peripherals of these devices, or any combination thereof. In some embodiments, the electronic device 110 can also support any type of interface for a user (such as a “wearable” circuit, etc.) .

It should be understood that the structures and functions of various elements in the environment 100 are described for example purposes only and do not imply any limitation to the scope of the present disclosure.

Some example embodiments of the present disclosure will be described below with continued reference to accompanying drawings.

### Example Processes

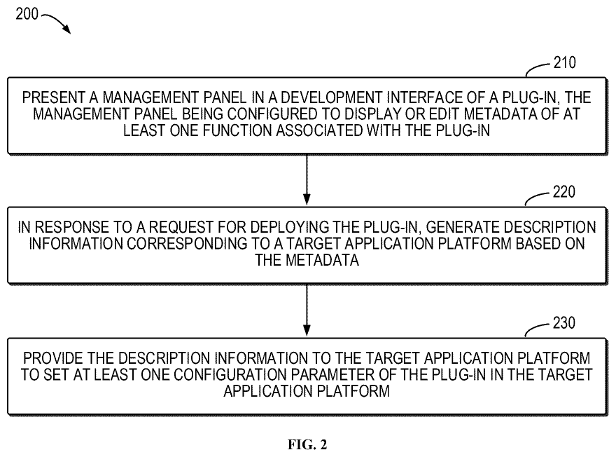

FIG. 2 illustrates a flowchart of an example process 200 for configuring a plugin according to some embodiments of the present disclosure. Process 200 may be implemented, for example, at the electronic device 110 as shown in FIG. 1.

As shown in FIG. 2, at block 210, the electronic device 110 presents a management panel in a development interface of a plug-in, the management panel being configured to display or edit metadata of at least one function associated with the plug-in.

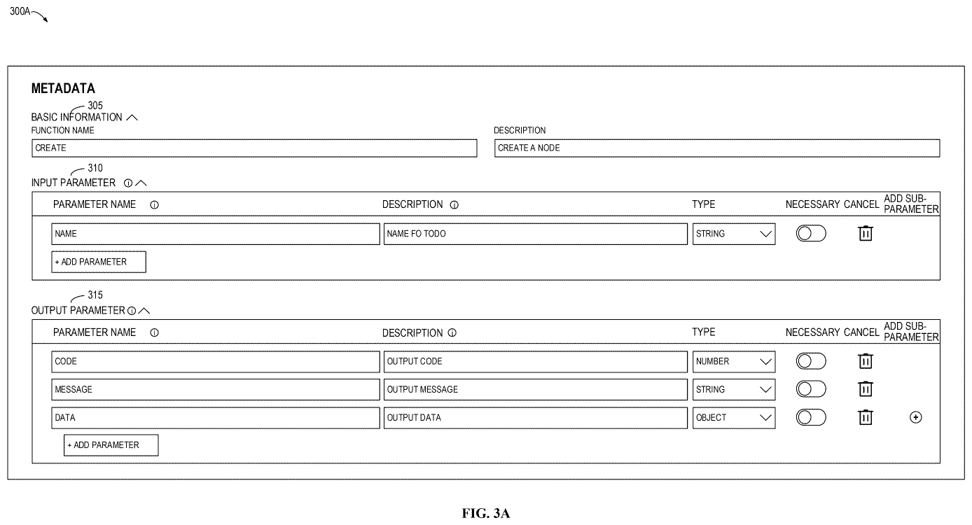

Process 200 will be described below with reference to FIGS. 3A and 3B. FIGS. 3A and 3B illustrate example development interfaces 300A and 300B in accordance with some embodiments of the present disclosure.

As shown in FIG. 3A, the electronic device 110 may provide a development interface 300A as shown in FIG. 3A by using an integrated development environment, and may display a management panel for managing metadata in the development interface 300A.

In some embodiments, the management panel as shown in FIG. 3A may display metadata of at least one function in the plug-in. As an example, such metadata may include basic information 305 of a function, e.g., an identifier (e.g., name) of the function and a functional description of the function, and/or the like.

Additionally, metadata may include input information 310 of a function. As an example, the management panel may display one or more input parameter of the function and display name(s), description(s), type(s), necessities, and/or the like of the input parameter(s).

Additionally, the metadata may include output information 315 of a function. As an example, the management panel may display one or more output parameter of the function and display name(s), description(s), type(s), necessities, and/or the like of the output parameter(s).

In some embodiments, the integrated development environment may automatically determine the above metadata based on an analysis of the code representation of the function. For example, the integrated development environment may extract corresponding metadata according to a preset grammar rule, or may determine corresponding metadata by using a language model or the like.

In some embodiments, the electronic device 110 may also support a user in manually inputting metadata or editing metadata through the management panel. For example, the user may add new parameters or modify information of parameter(s), etc. by input control(s) provided in the management panel.

Thereby, embodiments of the present disclosure can support visual management of metadata, thereby improving the efficiency of metadata management.

With continued reference to FIG. 2, at block 220, in response to a request for deploying the plug-in, the electronic device 110 generates description information corresponding to the target application platform based on the metadata.

Further, as shown in FIG. 3B, after receiving the request for deploying the plug-in, the electronic device 110 may present the interface 300B shown in FIG. 3B to display deployment information.

As shown in FIG. 3B, interface 300B may display function information 320 in the plug-in, such as one or more function included in the plug-in and access path(s) thereof.

Additionally, the electronic device 110 may also display the description information 325 generated based on the metadata in the management panel in the interface 300B. In some embodiments, such description information 325 is, for example, structured data generated based on metadata. For example, the specific data format of such structured data may be determined depending on the type of target application platform to be released.

For example, different application platforms may correspond to different plug-in configuration interfaces or plug-in configuration rules. The format of the structured data generated by the electronic device 110 may be matched to such configuration interface or configuration rule.

With continued reference to FIG. 2, at block 230, the electronic device 110 provides the description information to the target application platform to set at least one configuration parameter of the plug-in in the target application platform.

In some embodiments, if the target application platform supports configuring a plug-in through an interface, the electronic device 110 may provide the description information to the target application platform by using an interface corresponding to the target application platform. Accordingly, the target application platform may automatically set one or more configuration parameter of the plug-in to be released according to the metadata indicated in the description information.

In still other embodiments, the electronic device 110 may, for example, access a corresponding integrated development environment through a browser, and the electronic device 110 may store such description information by using a target tool of the browser.

Further, when the browser displays a configuration interface for configuring a plug-in in the target application platform, the electronic device 110 may automatically fill the corresponding information item in the configuration interface by using the target tool of the browser, thereby completing the setting of the one or more configuration parameter of the plug-in.

In still other embodiments, the electronic device 110 may also generate and provide an access address 330 corresponding to the description information 325, for example. Further, a user may input or paste the access address 330 (for example, after clicking a duplication button 335) in the target application platform, so that the target application platform obtains the description information based on the access address, and sets one or more configuration parameter of the plug-in to be released.

Thereby, embodiments of the invention can couple plug-in's development platform with application platform, and thus realize a linkage of plug-in development and plug-in release and reduce development cost of the developer.

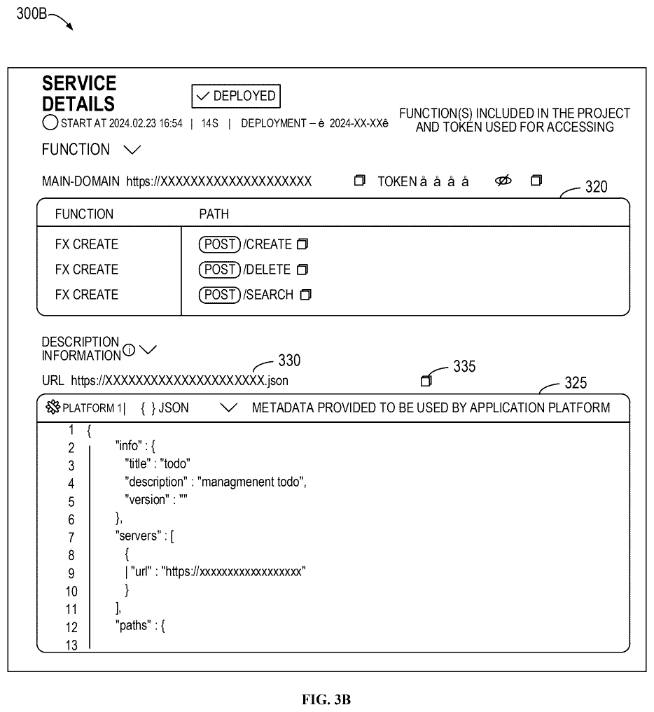

FIG. 4 further illustrates a schematic diagram 400 for plug-in development according to some embodiments of the present disclosure. As shown in FIG. 4, the development life cycle of a plug-in may include, for example, four stages, namely, a development stage of the plug-in, a deployment stage of the plug-in, a stage of linked agent platform, and a stage of online running.

As shown in FIG. 4, in the development stage, a developer 410 may, for example, create an agent item, and may write code(s) of the plug-in accordingly. As an example, the developer may utilize an integrated development platform to write related code(s) of a plug-in. In some examples, the code(s) may also be managed using a BaaS service for data storage or file storage, etc.

Further, as introduced above, such code(s) may, for example, utilize an integrated development environment to realize synchronous management of code metadata. For example, the integrated development environment may automatically generate metadata of all functions in the interface file, and perform synchronization management.

After editing the code(s) of the plug-in, the developer 410 may further perform a test run on the code(s). As an example, such a test run may include running a particular test case to assess whether its running result is accurate. In response, development of the plug-in may proceed to the deployment phase after the test is passed.

In the deployment stage, after receiving a deployment request, the integrated development environment may construct a code based on code(s) in the plug-in, and may, for example, pack the code and upload it to the deployment platform. The deployment platform may be implemented, for example, based on a cloud service. Accordingly, the code package may be deployed as a cloud function such that other devices may invoke the cloud function through a network address.

Further, as discussed above, depending on the type of an agent platform, the integrated development environment may provide metadata of the function to the agent platform through an API, or may also import metadata into the agent platform by means of a browser tool (e.g., plug-in). Thus, the integrated development environment can complete the deployment process of the plug-in.

Further, as shown in FIG. 4, in the linked agent platform stage, an agent user 420 may create a corresponding agent in the agent platform. Further, the agent user 420 may configure an agent of the homepage, so that others can invoke plug-in(s) or action(s) released in the agent platform.

As introduced above, the plug-in(s) or action(s) released in the agent platform may be automatically configured based on metadata of a function of the plug-in code(s). Thus, such agents may invoke released plug-in(s) or action(s). In the specific invoking process, the agent may invoke a corresponding cloud function according to the access address of the deployment platform in which the plug-in is deployed, so as to trigger the deployment platform to execute the corresponding function code(s). Further, the agent may obtain an execution result of the cloud function from the deployment platform as a response result.

Further, the agent may consume the execution result of the plug-in code(s), and provide a corresponding response content to the user, thereby completing the execution of the agent. For example, the agent may generate a corresponding reply message according to the execution result of the plug-in code(s) which acts as a response content to a user-specific request.

Based on the process described above, embodiments of the present disclosure can couple the plug-in development environment with the application platform, so that metadata can be synchronized to the application platform to complete automatic configuration and release of the plug-in, thereby improving the efficiency of plug-in development and configuration.

### Example Apparatus and Device

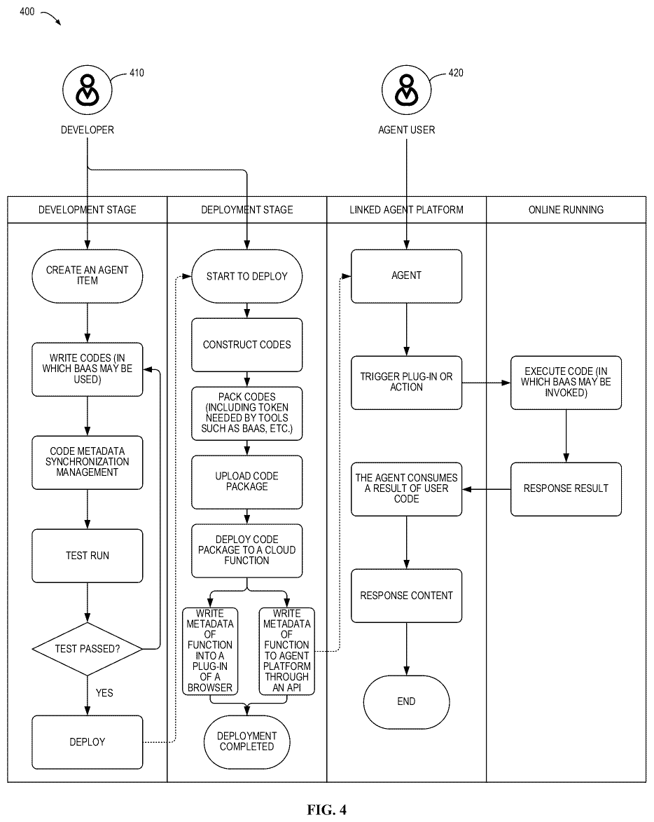

Embodiments of the present disclosure also provide a corresponding apparatus for implementing the above method or process. FIG. 5 shows a schematic structural block diagram of an example apparatus 500 for configuring a plug-in according to some embodiments of the present disclosure. The apparatus 500 may be implemented or included in an electronic device. Various modules/components in the apparatus 500 may be implemented by hardware, software, firmware, or any combination thereof.

As shown in FIG. 5, the apparatus 500 comprises a presentation module 510 configured to present a management panel in a development interface of a plug-in, the management panel being configured to display or edit metadata of at least one function associated with the plug-in; a generation module 520 configured to in response to a request for deploying the plug-in, generate description information corresponding to a target application platform based on the metadata; and a provision module 530 configured to provide the description information to the target application platform to set at least one configuration parameter of the plug-in in the target application platform.

In some embodiments, the metadata comprises at least one of the following: an identifier of the at least one function; a function description of the at least one function; input information of the at least one function; or output information of the at least one function.

In some embodiments, the metadata of the at least one function is determined based on an analysis of a code representation of the at least one function.

In some embodiments, the description information comprises structured data generated based on the metadata.

In some embodiments, the provision module 530 is further configured to: provide the description information to the target application platform by using an interface corresponding to the target application platform, wherein the description information is of a data format matching the interface.

In some embodiments, the development interface is provided by a browser, and the provision module 530 is further configured to: store the description information by using a target tool of the browser; and in response to the browser displaying a configuration interface for configuring the plug-in in the target application platform, fill a corresponding information item in the configuration interface with the target tool.

In some embodiments, the provision module 530 is further configured to: generate an access address corresponding to the description information, so that the target application platform obtains the description information based on the access address.

In some embodiments, the apparatus 500 further includes a deployment module configured to: deploy the plug-in at the deployment platform to support invoking the at least one function in the plug-in by using a cloud function.

In some embodiments, the target application platform comprises a platform for developing an agent configured to be able to invoke the plug-in.

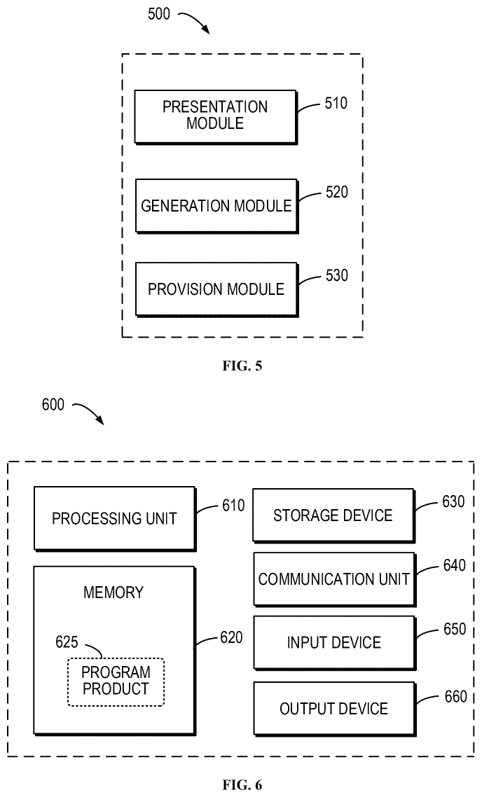

FIG. 6 illustrates a block diagram of an electronic device 600 in which one or more embodiment of the present disclosure may be implemented. It should be understood that the electronic device 600 illustrated in FIG. 6 is merely example and should not constitute any limitation on the function and scope of the embodiments described herein. The electronic device 600 shown in FIG. 6 may be used for an electronic device.

As shown in FIG. 6, the electronic device 600 is in the form of a general-purpose electronic device. Components of the electronic device 600 may include, but not limited to, one or more processor or processing unit 610, a memory 620, a storage device 630, one or more communication unit 640, one or more input device 650, and one or more output device 660. The processing unit 610 may be an actual or virtual processor and capable of performing various processes according to program(s) stored in the memory 620. In multi-processor systems, a plurality of processing units execute computer-executable instructions in parallel to improve parallel processing capability of the electronic device 600.

Electronic device 600 typically includes a plurality of computer storage mediums. Such mediums may be any available medium accessible to the electronic device 600, including, but not limited to, volatile and non-volatile medium, removable and non-removable medium. Memory 620 may be a volatile memory (e.g., register, cache, random access memory (RAM)), non-volatile memory (e.g., read-only memory (ROM), electrically erasable programmable read-only memory (EEPROM), flash memory), or some combination thereof. Storage device 630 may be a removable or non-removable medium and may include a machine-readable medium, such as flash drive, magnetic disk, or any other medium, which may be capable of storing information and/or data and may be accessed within electronic device 600.

Electronic device 600 may further include additional removable/non-removable, volatile/non-volatile storage medium. Although not shown in FIG. 6, a disk drive for reading or writing from a removable, non-volatile magnetic disk (e.g., a “soft disk”) and an optical disk drive for reading or writing from a removable, non-volatile optical disk may be provided. In these cases, each drive may be connected to a bus (not shown) by one or more data medium interface. Memory 620 may include a computer program product 625 having one or more program module configured to perform various methods or actions of various embodiments of the present disclosure.

Communication unit 640 is implemented to communicate with another electronic device through a communication medium. Additionally, functions of components of electronic device 600 may be implemented in a single computing cluster or a plurality of computing machines capable of communicating over a communication connection. Thus, electronic device 600 may operate in a networked environment using logical connections with one or more other server, network personal computers (PCs), or another network node.

Input device 650 may be one or more input device such as mouse, keyboard, trackball, or the like. Output device 660 may be one or more output device, such as display, speaker, printer, or the like. Electronic device 600 may also communicate with one or more external device (not shown) such as storage device, display device, etc. through communication unit 640 as needed, communicate with one or more device that enables a user to interact with electronic device 600, or communicate with any device (e.g., network card, modem, etc.) that enables electronic device 600 to communicate with one or more other electronic device. Such communication may be performed via an input/output (I/O) interface (not shown).

According to example implementations of the present disclosure, there is provided a computer-readable storage medium having computer-executable instructions stored thereon, wherein the computer-executable instructions are executed by a processor to implement the method described above. According to example implementations of the present disclosure, a computer program product is further provided, the computer program product being tangibly stored on a non-transitory computer-readable medium and including computer-executable instructions, the computer-executable instructions being executed by a processor to implement the method described above.

Various aspects of the present disclosure are described herein with reference to flowchart(s) and/or block diagram(s) of the method, apparatus, device, and computer program product implemented in accordance with the present disclosure. It should be understood that each of the block(s) of the flowchart(s) and/or block diagram(s) and combination(s) of respective blocks in the flowchart(s) and/or block diagram(s) may be implemented by computer-readable program instructions.

These computer-readable program instructions may be provided to a processing unit of a general purpose computer, a special purpose computer, or another programmable data processing apparatus to produce a machine, such that the instructions, when executed by a processing unit of a computer or another programmable data processing apparatus, produce means to implement the functions/actions specified in one or more block of the flowchart(s) and/or block diagram(s). These computer-readable program instructions, which cause the computer, the programmable data processing apparatus and/or the other device to operate in a particular manner, may also be stored in a computer-readable storage medium, such that the computer-readable medium storing instructions includes a manufactured article including instructions to implement various aspects of the functions/actions specified in one or more block of the flowchart(s) and/or block diagram(s).

The computer-readable program instructions may be loaded onto a computer, another programmable data processing apparatus, or another device, such that a series of operational steps are performed on the computer, the other programmable data processing apparatus, or the other device to produce a computer-implemented process, thereby enabling instructions executed on the computer, the other programmable data processing apparatus, or the other device to implement the functions/actions specified in one or more block of the flowchart(s) and/or block diagram(s).

The flowchart(s) and block diagram(s) in the drawings show architecture(s), function(s), and operation(s) possibly implemented by system(s), method(s), and computer program product(s) according to a plurality of implementations of the present disclosure. In this regard, each block in the flowchart(s) or block diagram(s) may represent a module, a program segment, or a portion of instructions that includes one or more executable instruction for implementing a specified logic function. In some alternative implementations, the functions noted in the blocks may also occur in a different order from that noted in the drawings. For example, two consecutive blocks may actually be performed substantially in parallel, or may sometimes be performed in a reverse order, depending on the functions involved. It is also noted that each block in the block diagram(s) and/or flowchart(s) as well as combination(s) of blocks in the block diagram(s) and/or flowchart(s) may be implemented with a dedicated hardware-based system that performs specified functions or actions, or may be implemented with a combination of dedicated hardware and computer instructions.

Various implementations of the present disclosure have been described above, which are example and not exhaustive, and the implementations disclosed are not limiting. Many modifications and variations will be apparent to those ordinary skilled in the art without departing from the scope and spirit of the various implementations illustrated. The selection of the terms used herein is intended to best explain the principles, practical applications, or improvements to techniques in the marketplace of respective implementations, or to enable other ordinary skilled in the art to understand respective implementations disclosed herein.

1. A method for configuring a plug-in, comprising:
presenting a management panel in a development interface of a plug-in, the management panel being configured to display or edit metadata of at least one function associated with the plug-in;
in response to a request for deploying the plug-in, generating description information corresponding to a target application platform based on the metadata; and
providing the description information to the target application platform to set at least one configuration parameter of the plug-in in the target application platform.

2. The method of claim 1, wherein the metadata comprises at least one of:
an identifier of the at least one function;
a function description of the at least one function;
input information of the at least one function; or
output information of the at least one function.

3. The method of claim 1, wherein the metadata of the at least one function is determined based on an analysis of a code representation of the at least one function.

4. The method of claim 1, wherein the description information comprises structured data generated based on the metadata.

5. The method of claim 1, wherein providing the description information to the target application platform comprises:
providing the description information to the target application platform by using an interface corresponding to the target application platform, wherein the description information is of a data format matching the interface.

6. The method of claim 1, wherein the development interface is provided by a browser, and providing the description information to the target application platform comprises:
storing the description information by using a target tool of the browser; and
in response to the browser displaying a configuration interface for configuring the plug-in in the target application platform, filling a corresponding information item in the configuration interface with the target tool.

7. The method of claim 1, wherein providing the description information to the target application platform comprises:
generating an access address corresponding to the description information, so that the target application platform obtains the description information based on the access address.

8. The method of claim 1, further comprising:
deploying the plug-in at a deployment platform to support invoking the at least one function in the plug-in by using a cloud function.

9. The method of claim 1, wherein the target application platform comprises a platform for developing an agent configured to be able to invoke the plug-in.

10. (canceled)

11. An electronic device, comprising:
at least one processor; and
at least one memory coupled to the at least one processor and storing instructions for execution by the at least one processor, the instructions, when executed by the at least one processor, causing the electronic device to perform acts comprising:
presenting a management panel in a development interface of a plug-in, the management panel being configured to display or edit metadata of at least one function associated with the plug-in;
in response to a request for deploying the plug-in, generating description information corresponding to a target application platform based on the metadata; and
providing the description information to the target application platform to set at least one configuration parameter of the plug-in in the target application platform.

12. A non-transitory computer-readable storage medium having a computer program stored thereon, the computer program being executable by a processor to perform acts comprising:
presenting a management panel in a development interface of a plug-in, the management panel being configured to display or edit metadata of at least one function associated with the plug-in;
in response to a request for deploying the plug-in, generating description information corresponding to a target application platform based on the metadata; and
providing the description information to the target application platform to set at least one configuration parameter of the plug-in in the target application platform.

13. The electronic device of claim 11, wherein the metadata comprises at least one of:
an identifier of the at least one function;
a function description of the at least one function;
input information of the at least one function; or
output information of the at least one function.

14. The electronic device of claim 11, wherein the metadata of the at least one function is determined based on an analysis of a code representation of the at least one function.

15. The electronic device of claim 11, wherein the description information comprises structured data generated based on the metadata.

16. The electronic device of claim 11, wherein providing the description information to the target application platform comprises:
providing the description information to the target application platform by using an interface corresponding to the target application platform, wherein the description information is of a data format matching the interface.

17. The electronic device of claim 11, wherein the development interface is provided by a browser, and providing the description information to the target application platform comprises:
storing the description information by using a target tool of the browser; and
in response to the browser displaying a configuration interface for configuring the plug-in in the target application platform, filling a corresponding information item in the configuration interface with the target tool.

18. The electronic device of claim 11, wherein providing the description information to the target application platform comprises:
generating an access address corresponding to the description information, so that the target application platform obtains the description information based on the access address.

19. The electronic device of claim 11, further comprising:
deploying the plug-in at a deployment platform to support invoking the at least one function in the plug-in by using a cloud function.

20. The electronic device of claim 11, wherein the target application platform comprises a platform for developing an agent configured to be able to invoke the plug-in.

21. The non-transitory computer-readable storage medium of claim 12, wherein the metadata comprises at least one of:
an identifier of the at least one function;
a function description of the at least one function;
input information of the at least one function; or
output information of the at least one function.
